(19) United States
(12) Patent Application Publication
(10) Pub. No.: US 2014/0062402 A1
(43) Pub. Date: Mar. 6, 2014

(54) CHARGER FOR MULTIPLE ELECTRIC VEHICLES WITH TOGGLE SWITCH FEATURE

(71) Applicants: Michael Farkas, Miami Beach, FL (US); Michael Kinard, Miami Beach, FL (US)

(72) Inventors: Michael Farkas, Miami Beach, FL (US); Michael Kinard, Miami Beach, FL (US)

(21) Appl. No.: 14/016,634

(22) Filed: Sep. 3, 2013

Related U.S. Application Data
(60) Provisional application No. 61/695,839, filed on Aug. 31, 2012.

(51) Int. Cl. B60L 11/18

(52) U.S. Cl. CPC B60L 11/1818
USPC 320/109

(57) ABSTRACT

A charging station for an electric vehicle comprises an electric vehicle charging apparatus, a plurality of plugs, wherein each plug connects the charging apparatus with an electric vehicle, a toggle switch in the charging apparatus for activating and deactivating current from the charging apparatus to each of the plurality of plugs and a processor configured for detecting when charging is complete for a first electric vehicle connected to a first plug, deactivating current to the first plug and activating current to a second plug connected to a second electric vehicle.

### CROSS-REFERENCE TO RELATED APPLICATIONS

This patent application claims priority to provisional patent application No. 61/695,839 filed Aug. 31, 2012 and titled “Charger for Multiple Electric Vehicles with Toggle Switch Feature.” The subject matter of provisional patent application No. 61/695,839 is hereby incorporated by reference in its entirety.

### STATEMENT REGARDING FEDERALLY SPONSORED RESEARCH OR DEVELOPMENT

Not Applicable.

### FIELD OF THE INVENTION

The present invention relates to the field of electric vehicles and, more specifically, the present invention relates to the field of charging apparatuses for electric vehicles.

### BACKGROUND OF THE INVENTION

Charging stations for electric vehicles typically include a cord extending from the main housing and a socket or plug at the end of the cord for connecting to a terminal on an electric vehicle. Currently, charging stations have one cord per charger that is used to recharge the battery of one electric vehicle at a time. Typically, a driver of an electric vehicle will park his vehicle adjacent to the charging station, plug his vehicle into the charging station and then return after the charging cycle, which can be up to 6 or 8 hours later. Consequently, many electric vehicle users charge their vehicles overnight or during a long stay, such as while they are at work.

One of the drawbacks of the currently available car charging stations is that users will leave their electric vehicles in place, even after the vehicle has fully charged. This happens often, since charging times can be so long and it is inconvenient to move the car, especially overnight. Consequently, the plug used by the vehicle remains taken and unusable by other electric vehicles, leaving the car charging station idle, even though other users are in need of it. This limits the use of the car charging station and irritates other users of the car charging station.

Therefore, what is needed is a system and method for improving the problems with the prior art, and more particularly for an apparatus and system for optimizing the use of charging apparatuses for electric vehicles.

### BRIEF SUMMARY OF THE INVENTION

Embodiments of the present invention address deficiencies of the art in respect to conductive charging of electric vehicles and provide a novel and non-obvious apparatus and system for performing electric charging of electric vehicles. In an embodiment of the invention, a charging station for an electric vehicle comprises an electric vehicle charging apparatus, a plurality of plugs, wherein each plug connects the charging apparatus with an electric vehicle, a toggle switch in the charging apparatus for activating and deactivating current from the charging apparatus to each of the plurality of plugs and a processor configured for detecting when charging is complete for a first electric vehicle connected to a first plug, deactivating current to the first plug and activating current to a second plug connected to a second electric vehicle.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a block diagram of a car charging system, in accordance with one embodiment of the present invention.

FIG. 2 is a block diagram illustrating a cord and plug, in accordance with one embodiment of the present invention.

FIG. 3 is a block diagram illustrating an electrical relay, in accordance with one embodiment of the present invention.

FIG. 4 is a block diagram of a system including an example computing device 400 and other computing devices.

### DETAILED DESCRIPTION OF THE INVENTION

The present invention improves upon the problems with the prior art by optimizing the use of electric vehicle charging apparatuses. The present invention allows more electric vehicles to plug into a car charging station than the car charging station has the ability to charge at one time. Using a toggle switch feature, the charging apparatus proceeds to sequentially charge each vehicle to a full charge, without requiring any plugs to be removed and inserted during the charging process. This ensures that the use of the charging apparatus is optimized and reduces or eliminates instances where an electric vehicle user cannot use a plug because another fully-charged vehicle is still occupying it. The present invention may also make use of off-peak grid hours to charge electric vehicles. This feature is especially useful in multifamily residential properties, where much of the charging is performed at night. Effectively, an electric vehicle user may plug in and charge his vehicle now, or plug in and elect to wait until off peak hours to charge his vehicle and save money.

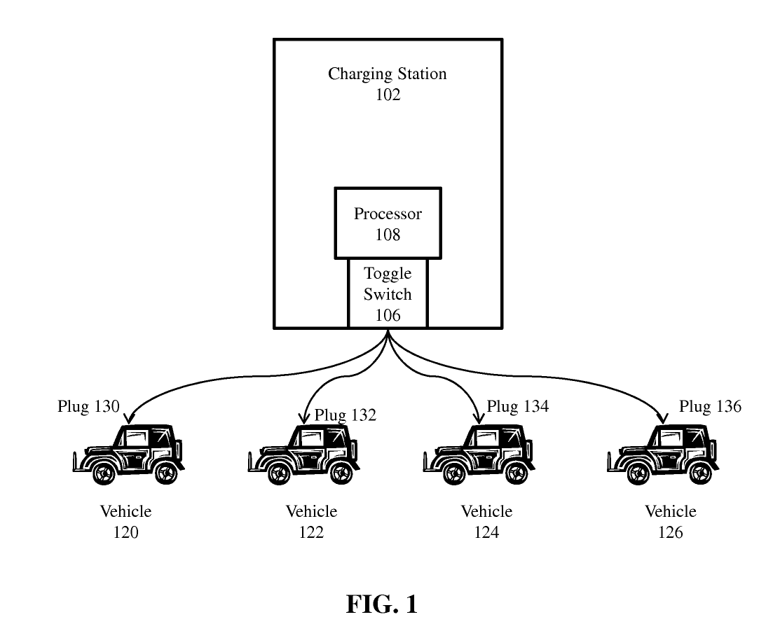

FIG. 1 is a block diagram illustrating a block diagram of a car charging system, in accordance with one embodiment of the present invention. FIG. 1 shows car charging station 102, which provides charging services to electric vehicles, such as electric vehicles 120-126. The car charging station 102 may be conductive and/or inductive chargers (Level I, Level II or DC Fast Charging Stations). The car charging station 102 includes processor 108 and toggle switch 106. The processor 108 can be one or more microprocessors contained in one housing or location or in a distributed fashion. The processor 108 can be one or more computers, described in greater detail below. The toggle switch 106 can be an electrical relay that activates or deactivates current from one or more source lines (or conductive pathways) to one or more destination lines. The toggle switch 106 may be controlled by processor 108. FIG. 3 shows an example of an electrical relay 304, wherein electrical current is relayed between a source line 302 and four destination lines 306, 308, 310 and 312. FIG. 3 shows that the electrical relay 304 is currently relaying electrical current from the source line 302 to destination line 306.

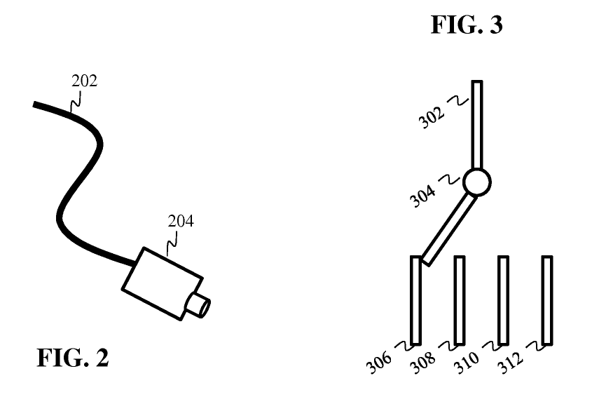

The toggle switch 106 is further connected to four plugs 130, 132, 134 and 136. Each plug comprises a cord extending from the main housing of the charging station 102 and a socket or plug at the end of the cord for connecting to a terminal on an electric vehicle. FIG. 2 illustrates a cord 202 and a plug 204. FIG. 1 shows that plug 130 has been connected to electric vehicle 120, plug 132 has been connected to electric vehicle 122, plug 134 has been connected to electric vehicle 124, and plug 136 has been connected to electric vehicle 126.

It is assumed that the charging station 102 only has the capacity to charge a certain number of electric vehicles at one time. By way of example only, the charging station 102 has the capacity to charge two electric vehicles at one time. Note, however, that all four electric vehicles 120-126 are connected to the charging station 102. Thus, if all four vehicles 120-126 are plugged in at the same time, the charging station chooses two electric vehicles for charging. In the present invention, the processor 108 controls the toggle switch 106 so as to activate current from its source to plugs 130 and 132, thereby charging vehicles 120 and 122.

When the processor 108 detects that one of the charging vehicles is fully charged, the processor 108 then deactivates the plug from the charged vehicle and activates the plug for another vehicle seeking a charge. For example, when the processor 108 detects that vehicle 120 is fully charged, the processor 108 sends a command to toggle switch 106 to deactivate the plug 130 and subsequently sends a command to toggle switch 106 to activate the plug 134 for vehicle 124, which is seeking a charge. In this manner, as time passes, the charging station 102 continues deactivating those plugs for vehicles that are fully charged and activating those plugs for vehicles seeking charge, until all such vehicles are fully charged, without requiring any plugs to be physically removed from vehicles and plugged into others during the charging process.

The station 102 also has the capability of communicating with the vehicles 120-126 to determine the state of charge (the current charging capacity), and how quickly a vehicle draws electricity. This will allow the station 102 to schedule the charging of multiple vehicles throughout the night so that they will be ready at the appropriate time in the morning. This will also allow the unit to move as much usage as possible to ‘off peak’ times. Also, a vehicle owner can input into the station 102 (via an interface, for example) what time the owner requires his vehicle to be fully charged in the morning, or the user can indicate that he needs the vehicle charged immediately. Based on this input, the station 102 calculates when to charge each vehicle.

Note the station 102 may be located behind a wall or on a different floor with simple plugs emanating from the wall. Thus, having one charging station with multiple charging cords to service multiple vehicles is advantageous because it reduces the cost of materials necessary to construct parking spaces that are electric-vehicle-charge ready.

The present invention improves over the prior art by providing a device that reduces the amount of infrastructure needed for car charging, while also reducing the burden or stress on the host electrical grid. For example, if four electric vehicles park in the parking garage of a condominium complex and each one plugs into a separate electrical charger, then all four vehicles will charge simultaneously during “on peak” hours. This produces a large burden on the electrical grid. If, however, the present invention is used, then only one charger is used, thereby reducing the infrastructure needed to service four electric vehicles. One electric charger requires only 25% of the wire, transformer, and generation capacity of four chargers. Further, the vehicles will be charged sequentially, thereby reducing the charging burden at one time. Further, the invention allows for the movement of some or all of the charging process to “off peak” hours when the electrical grid has plenty of capacity and wattage prices are lower.

Note that although FIG. 1 shows only four plugs and four electric vehicles, the present invention supports any number of plugs and electric vehicles. Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

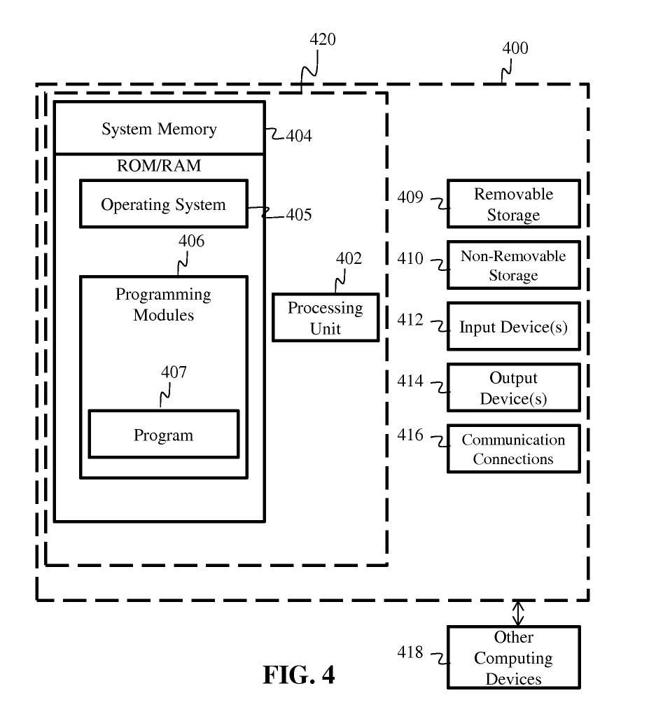

FIG. 4 is a block diagram of a system including an example computing device 400 and other computing devices. Consistent with the embodiments described herein, the aforementioned actions performed by processor 108 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device.

With reference to FIG. 4, a system consistent with an embodiment of the invention may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, one or more programming modules 406 (such as program module 407). Operating system 405, for example, may be suitable for controlling computing device 400's operation. In one embodiment, programming modules 406 may include, for example, a program module 407. Furthermore, embodiments of the invention may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. The aforementioned devices are only examples, and other devices may be added or substituted.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 may perform processes including, for example, one or more of the methods described above with reference to processor 108. The aforementioned processes are examples, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A charging station for an electric vehicle, comprising:
an electric vehicle charging apparatus;
a plurality of plugs, wherein each plug connects the charging apparatus with an electric vehicle;
a toggle switch in the charging apparatus for activating and deactivating current from the charging apparatus to each of the plurality of plugs; and
a processor communicatively coupled with the toggle switch, the processor configured for detecting when charging is complete for a first electric vehicle connected to a first plug of the plurality of plugs, and transmitting a command to the toggle switch, wherein the command is configured for deactivating current to the first plug and activating current to a second plug connected to a second electric vehicle.

2. The charging station of claim 1, wherein each plug consists of a cord extending from the charging apparatus and a terminal located at the end of the cord for coupling with a terminal on an electric vehicle.

3. The charging station of claim 2, wherein the toggle switch consists of an electrical relay that both opens and closes a circuit to a plurality of electrical paths.

4. The charging station of claim 2, further comprising a receiver communicatively coupled with the processor, the receiver configured for receiving a status report from each electric vehicle coupled with any of the plurality of plugs, wherein a status report indicates a charging status of an electric vehicle.

5. A charging station for an electric vehicle, comprising:
an electric vehicle charging apparatus;
a plurality of plugs, wherein each plug connects the charging apparatus with an electric vehicle;
a toggle switch in the charging apparatus for activating and deactivating current from the charging apparatus to each of the plurality of plugs;
a receiver communicatively coupled with the processor, the receiver configured for receiving a status report from each electric vehicle coupled with any of the plurality of plugs, wherein a status report indicates a charging status of an electric vehicle; and
a processor communicatively coupled with the toggle switch, the processor configured for detecting, based on status report, when charging is complete for a first electric vehicle connected to a first plug of the plurality of plugs, and transmitting a command to the toggle switch, wherein the command is configured for deactivating current to the first plug and activating current to a second plug connected to a second electric vehicle.

6. The charging station of claim 5, wherein each plug consists of a cord extending from the charging apparatus and a terminal located at the end of the cord for coupling with a terminal on an electric vehicle.

7. The charging station of claim 6, wherein the toggle switch consists of an electrical relay that both opens and closes a circuit to a plurality of electrical paths.
